(19) United States
(12) Patent Application Publication
(10) Pub. No.: US 2015/0149308 A1
(43) Pub. Date: May 28, 2015

(54) Method and System for Credit Card Selection at a Point of Sale

(71) Applicant: Daniel Lin, San Francisco, CA (US)

(72) Inventor: Daniel Lin, San Francisco, CA (US)

(21) Appl. No.: 14/089,758

(22) Filed: Nov. 26, 2013

(51) Int. Cl. G06Q 20/34; G06Q 30/02; G06Q 20/20

(52) U.S. Cl. CPC G06Q 20/351; G06Q 20/20; G06Q 30/0238
USPC 705/16; 705/14.38

(57) ABSTRACT

Embodiments herein provide systems and methods for selecting a credit card for a user at a point of sale. One method generally includes determining an identity of a business establishment corresponding to the point of sale where the user intends to complete a purchase transaction with one of a plurality of payment cards held by the user, providing the identity of the business establishment to at least a subset of issuers of the plurality of payment cards in order to receive details regarding rewards provided by each issuer in the subset to the user if the user uses a corresponding payment card for the purchase transaction at the business establishment, and presenting to the user a recommendation to use at least one of the payment cards for the purchase transaction based on received details regarding rewards from the issuers.

### BACKGROUND

Recent studies indicate that at least half of U.S. consumers hold more than one credit card. Multiple credit cards provide (i) a higher aggregate line of credit, (ii) different interest rate options, (iii) backup options in case one credit card is lost, stolen or not accepted, and (iv) different choices at a point of sale depending on the warranties, protections and other benefits offered by the different credit cards.

Credit card issuers are increasingly competing for customers by offering “rewards” when a customer utilizes his credit card at the point of sale. Issuers may implement a rewards program by allowing consumer to accumulate “points” for each dollar charged on a credit card, which can then be redeemed for merchandise, gift cards, airline miles and the like. Other reward programs may allow the credit card holder to earn cash-back for making purchases. In point-based, cash-back based or any other type of reward program, issuers may periodically provide opportunities for increased incentives (e.g., multiple points per dollar, higher percentage cash-back, etc.) from select merchants and/or entertainment events. Some of these opportunities may be offered by the issuer for only a limited time period. Issuers typically advertise these opportunities on their web sites. However, credit card holders rarely visit the web sites of credit card issuers and are often unaware of all the different rewards that their credit cards may provide. As such, credit card holders may make a purchase with a merchant using a “default” credit card that does not provide the best reward for that particular purchase. If the credit card holder had been aware of a particular reward offered by the credit card issuer at the point of sale, he may have used the issuers credit card rather than his default.

### SUMMARY

One or more embodiments disclosed herein provide a computerized method for selecting a credit card for a user at a point of sale. The method generally includes determining an identity of a business establishment corresponding to the point of sale where the user intends to complete a purchase transaction with one of a plurality of payment cards held by the user, providing the identity of the business establishment to at least a subset of issuers of the plurality of payment cards in order to receive details regarding rewards provided by each issuer in the subset to the user if the user uses a corresponding payment card for the purchase transaction at the business establishment, and presenting to the user a recommendation to use at least one of the payment cards for the purchase transaction based on received details regarding rewards from the issuers. Other embodiments include, without limitation, a computer-readable storage medium that includes instructions that enable a processing unit to implement one or more aspects of the disclosed methods as well as a computer system having a processor configured to implement one or more aspects of the disclosed methods.

### BRIEF DESCRIPTION OF THE DRAWINGS

FIG. 1 depicts a user interface for a mobile application for selecting a credit card at a point of sale, according to an embodiment.

FIG. 2 depicts a network architecture that is utilized by a mobile application for selecting a credit card at a point of sale, according to an embodiment.

FIG. 3 depicts a flow diagram depicting steps for determining a credit card to present to a credit card holder at a point of sale, according to an embodiment.

FIG. 4 depicts a user interface for selecting a credit card for an online transaction, according to an embodiment.

FIG. 5 depicts a user interface for a mobile application for enabling credit card issuers to compete for a purchase transaction by offering rewards, according to an embodiment.

FIG. 6 depicts a flow diagram depicting steps for enabling credit card issuers to compete for a purchase transaction, according to an embodiment.

### DETAILED DESCRIPTION

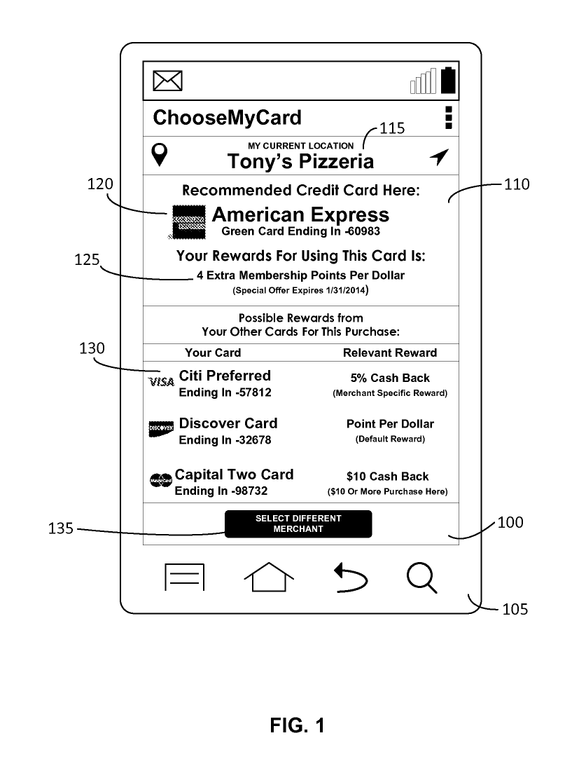

FIG. 1 depicts a user interface for a mobile application for selecting a credit card at a point of sale, according to an embodiment. In the embodiment of FIG. 1, when a user launches mobile application 100 on his mobile device 105, a user interface (“UI”) 110 of mobile application 100 depicts a current business name 115 of a current location of the user based on, for example, geographic data received from the geolocation services (e.g., Google Geocoding API, Google Places, API, etc.) of the operating system (e.g., Android, iOS, etc.) of mobile device 105. Based upon business name 115, mobile application 100 displays a recommended credit card 120 held by the user that should be used when conducting a purchase at the business. Mobile application 100 also displays the reward 125 associated with use of recommended credit card 105 at the business. Mobile application 100 further displays 130 the user's other credit cards and any corresponding rewards, if any, that may be awarded if such credit cards are used in lieu of recommended credit card 120. Mobile application 100 also presents a button or other UI widget 135 that enables the user to select, enter or otherwise identify a different business establishment or merchant if, for example, business name 115 does not properly reflect the user's correct location or the user simply desires to look up the rewards for a different business establishment or merchant. It should be recognized that user interface 110 is one particular user interface layout and that many alternative user interfaces may be designed and implemented within the scope and spirit of the teachings herein. For example, an alternative user interface may further enable the user to add or otherwise “activate” a reward (to the extent such activation is needed to take advantage of the reward) associated with one of the user's credit cards for the particular merchant or establishment where the user is located. Similarly, although FIG. 1 depicts mobile device 105 as a smartphone, alternative embodiments of mobile device 105 may include tablets, wearable computing devices (e.g., watches, glasses, etc.), laptop computers, and the like. It should further be recognized that alternative embodiments may implement applications that run on user terminals other than mobile devices, such as, for example, web applications that run within a web browser installed on any type of computing device.

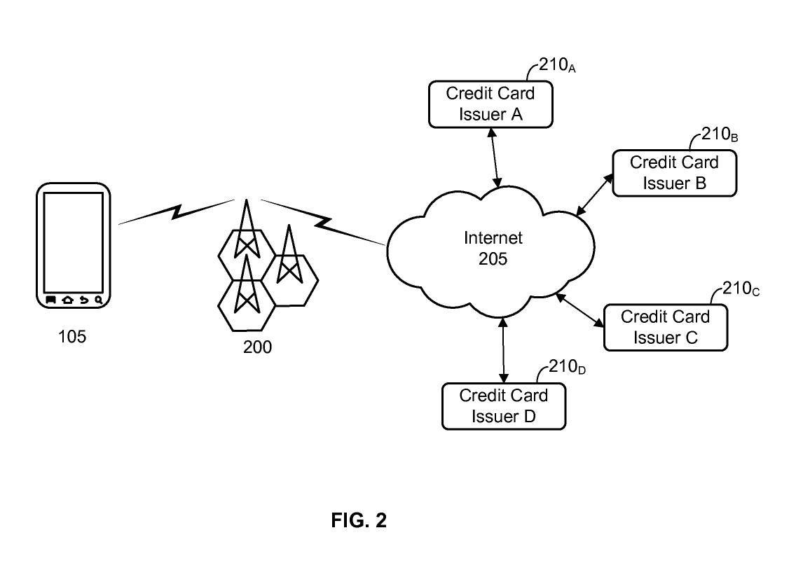

FIG. 2 depicts a network architecture that is utilized by mobile application 100 for selecting a credit card at a point of sale, according to an embodiment. Mobile device 105 communicates wirelessly through a cellular network 200 that enables mobile device 105 to communicate through the Internet 205 to various issuers 210ₓ of the credit cards held by the user. In one embodiment, when the user first installs and launches mobile application 100 on mobile device 105, mobile application 100 prompts the user to enter certain of his credentials (e.g., credit card numbers, name, expiration date, billing address, security code, etc.) for his various credit cards, which are then securely stored by mobile application 100 (e.g., encrypted, etc.). Mobile application 100 is then able to identify various card issuers 210ₓ corresponding to the user's credit cards and communicate with card issuers 210ₓ to obtain data regarding the rewards currently offered by each of card issuers 210ₓ. In one embodiment, card issuers 210ₓ may provide a RESTFUL API or other similar mechanism by which mobile application 100 is able to request and obtain rewards data (as well as other data such as historical purchase details, etc.). Such data may be provided by card issuers 210ₓ in JSON, XML, HTML or other similar tagged data formats such that mobile application 100 can parse the data and present it in user interface 110. The user may further input credit card “selection” criteria, such as identifying a default or preferred credit card to use (e.g., in the event that no credit cards held by the user offer any particular rewards at a particular merchant or establishment), reward types preferences (e.g., cash-back, points, etc.), card preferences for different types of purchases (e.g., food, entertainment, consumer goods, etc.) and the like. Such selection criteria can be used by mobile application 105 to prioritize different rewards to present to user through user interface 110 at a point of sale. In one embodiment, for each entered credit card, the user may further provide mobile application 105 a corresponding username and password (or other authentication mechanism) that enables mobile application 105 to establish secure connections with corresponding credit card issuers 210ₓ and obtain further data from credit card issuers 210ₓ such as the user's balance, purchase history and activity, more personalized rewards for the user and the like. It should be recognized that the network architecture in FIG. 2 is only one example of a network architecture that may support the techniques disclosed herein. For example, in an alternative network architecture, mobile device 105 may communicate wirelessly through its WiFi capabilities directly to Internet 205 rather than through cellular network 200. Similarly, in an alternative embodiment, the user may authorize mobile application 100 to access a virtual wallet application installed on mobile device 105 to obtain credit card information rather than having the user enter the credit card information separately into mobile application 100.

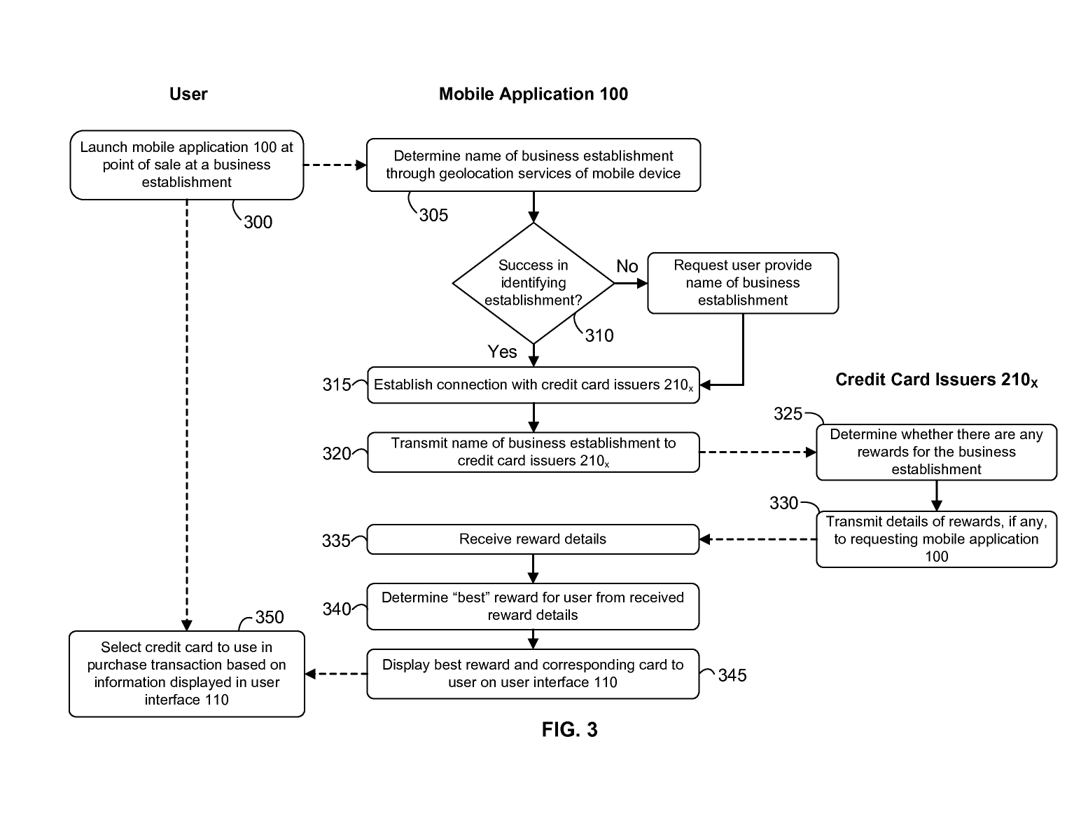

FIG. 3 depicts a flow diagram depicting steps for determining a credit card to present to a credit card holder at a point of sale, according to an embodiment. In step 300, when the user is ready to complete a purchase at a merchant, restaurant, or any other business establishment, he launches mobile application 100 on mobile device 105 at the point of sale. In step 305, mobile application 100 utilizes with the geolocation services provided by the operating system (e.g., Android, iOS, etc.) of mobile device 105 to determine the user's current location. It should be recognized that in some embodiments, the geolocation services provided by the operating system may be able to provide the name of the business establishment while in other embodiments, further translations (e.g., using other APIs of mobile device 105 or other third party services available through Internet 205, etc.) from geographic coordinates to map addresses to business establishment names may be required (e.g., sometimes referred to as “reverse geocoding”). If, in step 310, mobile application 100 is successful in identifying the business establishment through geolocation services or other means, then in step 315, mobile application 100 establishes a connection with each of card issuers 210 ₓ corresponding to credit cards held by the user. In step 320, mobile application transmits the name of the business establishment determined in step 305 to each of card issuers 210 ₓ (e.g., via APIs provided by card issuers 210ₓ, as previously discussed). In step 325, each of card issuers 210ₓ determines whether it currently offers any rewards or other benefits (e.g., cash-back, points, etc.) that correspond to the received business establishment, and in step 330, transmits back to mobile application 100 any details relating to any such rewards. In step 335, mobile application 100 receives the reward details and in step 340, determines the credit card that offers the “best” reward (e.g., recommended using objective criteria or other criteria specified by the user as previously discussed, depending upon the embodiment). In step 345, mobile application 100 displays and highlights the best reward (and identity of the corresponding credit card) to the user on user interface 110. In certain embodiments similar to FIG. 1, mobile application 100 may also display all the other credit cards of the user and the rewards, if any, that can be obtained if the user utilizes such other credit cards at this point of sale. If there are no particular rewards for the business establishment, mobile application 100 may simply display the user's default preferences and/or default rewards for the user's credit cards. In step 350, the user selects a credit card (presumably based upon the information displayed in user interface 110 in step 340) and completes a purchase at the point of sale with the credit card. Returning to step 310, if mobile application 100 cannot successfully identify a business establishment corresponding to the current location of the user, then in step 355, mobile application 100 may request or otherwise provide the user an ability to submit the name of a business establishment, upon which mobile application 100 returns to step 315. It should be recognized that the flow of FIG. 3 is merely exemplary and that many additional and/or alternative steps may be implemented in alternative embodiments without departing from the spirit and scope of the teachings herein. For example, in an alternative embodiment, rather than communicating directly with card issuers 210ₓ, mobile application 100 may interact with a service provided by a third party that communicates with card issuers 210ₓ to obtain the rewards data. In another embodiment, mobile application 100 may run in the background or is otherwise triggered to periodically communicate with card issuers 210ₓ (or a third party service) to download and cache rewards data that is relevant to the user's credit cards (e.g., as in step 335). In such an embodiment, mobile application 100 can display relevant rewards information to the user at the point of sale, even if it cannot successfully establish a connection with card issuers 210ₓ at the time of the user's purchase transaction. Similarly, in alternative embodiments, mobile application 100 may, in the background, periodically determine the user's location and transmit alerts (e.g., push notifications, etc.) to the user when mobile application 100 recognizes that the user is currently in a business establishment that offers a special reward for one of the user's credit cards.

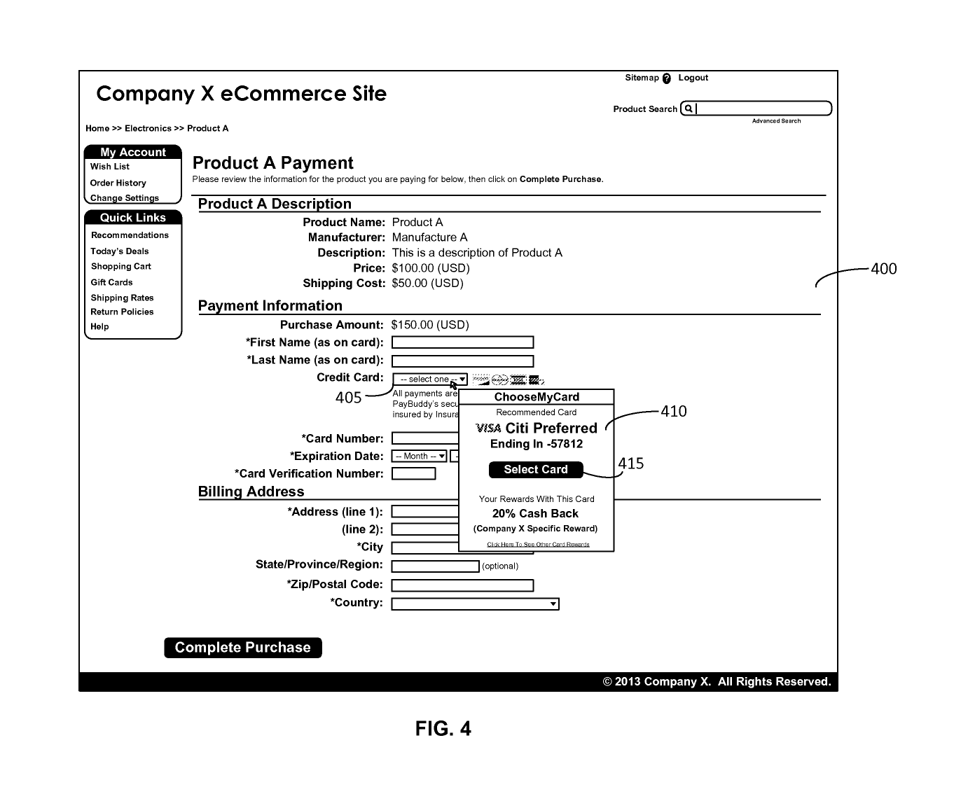

FIG. 4 depicts a user interface for selecting a credit card for an online transaction, according to an embodiment. In the embodiment of FIG. 4, a user has navigated to a payment web page 400 of an online merchant during a purchase transaction using a web browser or similar application (e.g., tablet application, etc.). When the user “mouses over,” touches or otherwise selects a credit card selection field 405 in the web page 400, a “pop-up” window 410 appears that displays a credit card held by the user that offers a recommended reward (e.g., similar to the discussions in FIG. 3). As depicted in the embodiment of FIG. 4, the user can then use the recommended card by selecting the “Select Card” button 415 in the pop-up window 410, which automatically populates the credit card information requested in payment web page 400. It should be recognized that the foregoing user interface may be implemented in a variety of ways. In one embodiment, the online merchant implements window 410 through web code (e.g., using web development technologies such as JavaScript, HTML5, XML, CSS, and/or other similar web development tools and techniques) provided by its web server to the user's web browser and obtains the user's credit card information that is displayed in window 410 from a user's registered account stored at the online merchant (or alternatively, from a third party provider as further discussed below). For example, in one such embodiment, online merchant obtains such web code from a third party provider that offers a service to communicate with card issuers 210ₓ. The web code then communicates with the third party provider in order to obtain the rewards data. Alternatively, the web code may communicate directly with card issuers 210ₓ. In an alternative embodiment, the user installs a web browser add-on, plug-in, extension, control or similar technology (e.g., generally referred to as “add-ons”) that monitors the user's browsing activities, identifies when the user browses to or otherwise selects a credit card selection field during a purchase transaction, determines an identification of the online merchant associated with the purchase transaction, and transmits the identification of the online merchant to either card issuers 210ₓ or a third party service to obtain rewards data to present in window 410. In such embodiments, the add-on may determine which card issuers 210ₓ to query for rewards data by consulting a local virtual wallet application (which includes the user's credit card information) accessible by the web browser or by consulting a third party service that maintains an account for the user that include the user's credit card information. It should further be recognized that the use interface of FIG. 4 is merely exemplary and that many alternative user interfaces may be designed consistent with the teachings herein. For example, in an alternative embodiment, rather than utilizing pop-up window 410, the recommended card and rewards may simply be displayed within web page 400 itself.

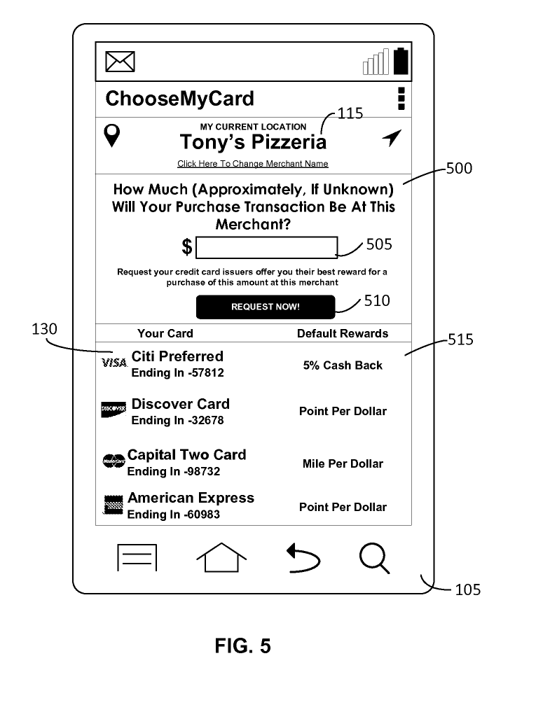

FIG. 5 depicts a user interface for a mobile application for enabling credit card issuers to compete for a purchase transaction by offering rewards, according to an embodiment. As depicted, user interface 500 of mobile application 100 enables the user to enter a purchase amount 505 (e.g., either exact or approximate) prior to completing a purchase transaction at a merchant location 115 recognized by mobile application 100 (e.g., via geolocation services of mobile device 105 or as otherwise entered by the user). Upon a selection of the “Request Now!” button 510 by the user, mobile application 100 communicates with card issuers 210ₓ to assess whether any of card issuers 210ₓ desire to increase their “default” reward (as shown in display 515), if any, to the user for the particular submitted transaction. The submission button 510 on user interface 500 enables a card issuer 210ₓ to consider a variety of factors (e.g., a particular purchase amount 505 at a particular merchant 115 by a particular user) to provide customized rewards (e.g., sometimes generally referred to as “price differentiation” or “discrimination”) in real time to a particular user at a point of sale to encourage the user to utilize the issuer's card over other cards held by the user. Given a particular user's profile (e.g., spending history, balance, etc.) with a particular card issuer 210ₓ, the card issuer may be more willing to provide increased customized rewards to such user. It should be recognized that the user interface depicted in FIG. 5 is merely one example design of a user interface for enabling card issuers 210ₓ to bid or otherwise compete on particular purchase transactions. Many other user interfaces may be contemplated that are consistent with the teachings herein. For example, in one alternative embodiment, user interface 500 does not request that the user submit a purchase amount but rather submits only the identity of the merchant and the user (e.g., as identified by the user's credit card number).

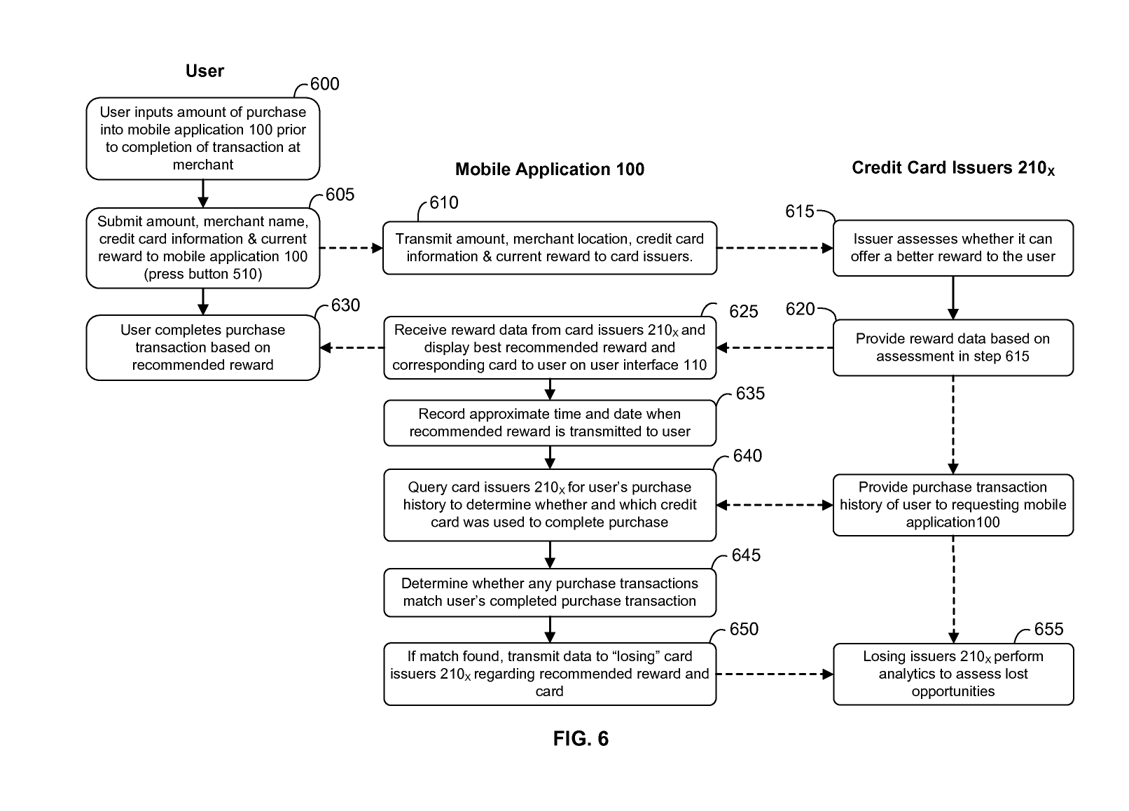

FIG. 6 depicts a flow diagram depicting steps for enabling credit card issuers to compete for a purchase transaction, according to an embodiment. In step 600, prior to completing a purchase transaction at a merchant or other business establishment, the user inputs an amount 505 (exact or approximate) of the purchase into user interface 500 of mobile application 100. In step 605, the user submits the amount through user interface 500 (e.g., button 510), upon which, in step 610, mobile application 100 transmits the amount, the merchant identification and the user's corresponding credit card information (e.g., as a user identification) to card issuers 210ₓ. In one embodiment, mobile application 100 further transmits to card issuers 210ₓ a current reward (and possibly the corresponding card issuer) that would be recommended to the user if other card issuers do not offer a better reward. Such a current reward, for example, may be the award associated with a default card held by the user (and stored by mobile application 100) or may have been obtained by mobile application 100 while it runs in the background, periodically requesting, downloading and storing rewards data from card issuers 210ₓ (or from a third party service provider that communicates with card issuers 210ₓ as the case may be). Upon receipt of the data (e.g., purchase amount, merchant identification, user identification, current reward, etc.) from step 610, card issuers 210ₓ assess whether they can offer the user a better reward than the current reward (or, alternatively, a “best” reward given the particular user, merchant and purchase amount, if no current reward is known or available in an embodiment) in step 615. In step 620, upon such assessment, card issuers 210ₓ provide rewards data back to mobile application 100 to present to the user. Mobile application 100 receives the rewards data in step 625 and presents a recommended reward and credit card to the user (and possible other reward and credit card options), for example through user interface 110 as described in FIG. 1. In step 630, the user completes the purchase transaction utilizing one of his credit cards, presumably based on the recommendation provided by mobile application 100.

The embodiment of FIG. 6 further provides feedback to card issuers 210ₓ based on the result of the user's completion of the purchase transaction in step 630. For example, in step 635, mobile application 100 records the approximate time and date when mobile application 100 presented the recommendation to the user in step 625. Subsequently, in step 640, mobile application 100 may query card issuers 210ₓ to determine whether the user completed the purchase transaction at the merchant location using the card recommended by mobile application 100. In one embodiment, mobile application 100 requests from each card issuer 210ₓ any purchase transactions (e.g., including purchase amount and merchant identification) made by the user with the issuer's credit card during the approximate time and date of the recommendation made in step 625 and then, in step 645, determines any whether of such transactions match the recommendations made in step 620. If, in step 645, mobile application 100 confirms that the user made a transaction with the recommended reward in step 625, then in step 650, mobile application 100 transmits data (e.g., reward details offered by the recommended card, winning card issuer, etc.) to each of the “losing” card issuers 210ₓ so that the “losing” card issuers, in step 655, are able perform analytics to assess their lost opportunities and determine whether they are capable of providing better rewards to the user (e.g., based on the user's spending activities) in the future. It should be recognized that the steps in FIG. 6 are merely one example embodiment and that alternative embodiments consistent with the teachings herein may be implemented with different steps. For example, in one alternative embodiment, as previously discussed, rather than communicating directly with card issuers 210ₓ, mobile application 100 may communicate with a third party service provider which, in turn, communicates with card issuers 210ₓ. In such an alternative embodiment, the third party service provider may also communicate with card issuers 210ₓ to confirm the purchase transaction in steps 640-645 and provide feedback to card issuers 210ₓ in step 650. Similarly, rather than communicating with card issuers 210ₓ in step 640 to obtain the user's purchase history in order confirm details of the completed purchase transaction, an alternative embodiment may implement a user interface in mobile application 100 requesting the user to input information regarding the purchase transaction (e.g., whether it was completed, which card was used, whether the offered rewards were a factor in selecting the card to use for the purchase transaction, etc.).

It should be further recognized that various modifications and changes may be made to the specific embodiments described herein without departing from the broader spirit and scope of the invention as set forth in the appended claims. For example, in one embodiment, the techniques herein may be utilized in conjunction with an electronic card (e.g., the size of a standard credit card) configured to hold multiple payment modalities (e.g., credit cards, debit cards, gift cards and the like, referred to generally as payment cards) and enabling a user to pay for transactions through a dynamic magnetic stripe on the card whose encoding can be changed to any of the payment modalities by the user by pressing a button or other interface on the electronic card (e.g., on such card is the Coin card offered by Coin, Inc., www.onlycoin.com). In such an embodiment, when mobile application 100 recommends a reward and corresponding credit card held by the user at a merchant location, mobile application 100 may automatically (or upon request by the user through a user interface of mobile application) communicate with the electronic card (e.g., via Bluetooth or other wireless or radio technology) so that the electronic card selects the corresponding credit card as the payment modality to use.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs) CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

1. A computerized method for selecting a credit card for a user at a point of sale comprising:
determining an identity of a business establishment corresponding to the point of sale where the user intends to complete a purchase transaction with one of a plurality of payment cards held by the user;
providing the identity of the business establishment to a service that communicates with at least a subset of issuers of the plurality of payment cards in order to receive details regarding rewards provided by each issuer in the subset to the user if the user uses a corresponding payment card for the purchase transaction at the business establishment; and
presenting to the user a recommendation to use at least one of the payment cards for the purchase transaction based on received details regarding rewards from the issuers.

2. The computerized method of claim 1, further comprising:
transmitting details regarding the purchase transaction to the subset of issuers prior to completion of the purchase transaction;
receiving at least one updated reward from one of the issuers based on the transmitted details, wherein the update reward is intended by the issuer to replace a currently selected default reward of one of the payment cards corresponding to one of the other issuers.

3. The computerized method of claim 2, wherein the details regarding the purchase transaction includes at least one of (i) an anticipated purchase amount for the purchase transaction, and (ii) the currently selected default reward for the purchase transaction.

4. The computerized method of claim 1, further comprising:
confirming that the purchase transaction was completed using the recommendation; and
transmitting data regarding the recommendation to issuers of payment cards that were not used to complete the purchase transaction.

5. The method of claim 4, wherein the confirming step further comprises:
obtaining purchase history information for the plurality of payment cards corresponding issuers; and
comparing the purchase history information with the recommendation to confirm whether the payment card in the recommendation was used to complete the purchase transaction.

6. The method of claim 1, wherein the method is performed by a mobile application running on a mobile device held by the user and the determining step further comprises accessing geolocation services of a mobile device held by the user.

7. The method of claim 1, wherein the method is performed by a web server during an online ecommerce transaction.

8.-13. (canceled)

14. A computer-readable storage medium storing instructions, which, when executed on a processor, performs an operation for selecting a credit card for by a user at a point of sale, the operation comprising:
determining an identity of a business establishment corresponding to the point of sale where the user intends to complete a purchase transaction with one of a plurality of payment cards held by the user;
providing the identity of the business establishment to a service that communicates with at least a subset of issuers of the plurality of payment cards in order to receive details regarding rewards provided by each issuer in the subset to the user if the user uses a corresponding payment card for the purchase transaction at the business establishment; and
presenting to the user a recommendation to use at least one of the payment cards for the purchase transaction based on received details regarding rewards from the issuers.

15. The computer-readable storage medium of claim 14, wherein the operation further comprises:
transmitting details regarding the purchase transaction to the subset of issuers prior to completion of the purchase transaction;
receiving at least one updated reward from one of the issuers based on the transmitted details, wherein the update reward is intended by the issuer to replace a currently selected default reward of one of the payment cards corresponding to one of the other issuers.

16. The computer-readable storage medium of claim 15, wherein the details regarding the purchase transaction includes at least one of (i) an anticipated purchase amount for the purchase transaction, and (ii) the currently selected default reward for the purchase transaction.

17. The computer-readable storage medium of claim 14, wherein the operation, further comprises:
confirming that the purchase transaction was completed using the recommendation; and
transmitting data regarding the recommendation to issuers of payment cards that were not used to complete the purchase transaction.

18. The computer-readable storage medium of claim 17, wherein the confirming step further comprises:
obtaining purchase history information for the plurality of payment cards corresponding issuers; and
comparing the purchase history information with the recommendation to confirm whether the payment card in the recommendation was used to complete the purchase transaction.

19. The computer-readable storage medium of claim 14, wherein the operation is performed by a mobile application running on a mobile device held by the user and the determining step further comprises accessing geolocation services of a mobile device held by the user.

20. (canceled)

21. A computerized method for recommending a credit card for a user during an online purchase transaction comprising:
determining, at a web browser, an identity of an online merchant corresponding to a web page that the user has navigated to and intends to complete an online purchase transaction with one of a plurality of payment cards held by the user;
providing the identity of the online merchant to a server to in order to receive details regarding rewards provided by at least one issuer of one of the payment cards if the user uses the payment card for the online purchase transaction at the online merchant; and
presenting to the user a recommendation to use at least one of the payment cards for the online purchase transaction based on received details regarding rewards from at least one issuer.

22. The computerized method of claim 21, further comprising:
receiving an indication from the user of an intent to use a payment card based on the recommendation; and
pre-populating a payment web page of the online merchant with information relating to the payment card.

23. The computerized method of claim 21, wherein the steps are performed by a web browser add-on.

24. The computerized method of claim 21, wherein the steps are performed by web code embedded in the web page of the online merchant.

25. The computerized method of claim 21, further comprising communicating with a virtual wallet application to identify the plurality of payment cards held by the user.

26. The computerized method of claim 21, wherein the steps are performed when the user selects a payment card selection field of a payment web page at the online merchant.

27. The computerized method of claim 26, wherein the presenting step comprises presenting a pop-up window in the web browser.
